(19) United States
(12) Patent Application Publication
(10) Pub. No.: US 2005/0193273 A1
(43) Pub. Date: Sep. 1, 2005

(54) Method, apparatus and program storage device that provide virtual space to handle storage device failures in a storage system

(75) Inventor: Todd R. Burkey, Savage, MN (US)

Correspondence Address: CRAWFORD MAUNU PLLC, 1270 NORTHLAND DRIVE, SUITE 390, ST. PAUL, MN, 55120, US

(73) Assignee: XIOtech Corporation

(21) Appl. No.: 10/781,594

(22) Filed: Feb. 18, 2004

(51) Int. Cl. G06F 11/00

(52) U.S. Cl. 714/42

(57) ABSTRACT

A method, apparatus and program storage device that provides virtual hot spare space to handle storage device failures in a storage system is disclosed. Data is migrated from a failed storage device to a hot spare storage device, which may be a virtual hot spare device spanning multiple physical storage devices or even existing as a subset of a single physical storage device, until a replacement storage device is hot swapped for the failed storage device. Once the replacement storage device is installed, the recovered data on the hot spare is moved back to the replacement storage device.

### BACKGROUND OF THE INVENTION

1. Field of the Invention

This invention relates in general to storage systems, and more particularly to a method, apparatus and program storage device that provide virtual hot spare space to handle storage device failures in a storage system.

2. Description of Related Art

Computer systems are constantly improving in terms of speed, reliability, and processing capability. As a result, computers are able to handle more complex and sophisticated applications. As computers improve, performance demands placed on mass storage and input/output (I/O) devices increase. There is a continuing need to design mass storage systems that keep pace in terms of performance with evolving computer systems.

A Disk array data storage system has multiple storage disk drive devices, which are arranged and coordinated to form a single mass storage system. There are three primary design criteria for mass storage systems: cost, performance, and availability, It is most desirable to produce memory devices that have a low cost per megabyte, a high input/output performance, and high data availability. “Availability” is the ability to access data stored in the storage system and the ability to insure continued operation in the event of some failure. Typically, data availability is provided through the use of redundancy wherein data, or relationships among data, are stored in multiple locations.

There are two common methods of storing redundant data. According to the first or “mirror” method, data is duplicated and stored in two separate areas of the storage system. For example, in a disk array, the identical data is provided on two separate disks in the disk array. The mirror method has the advantages of high performance and high data availability due to the duplex storing technique. However, the mirror method is also relatively expensive as it effectively doubles the cost of storing data.

In the second or “parity” method, a portion of the storage area is used to store redundant data, but the size of the redundant storage area is less than the remaining storage space used to store the original data. For example, in a disk array having five disks, four disks might be used to store data with the fifth disk being dedicated to storing redundant data. The parity method is advantageous because it is less costly than the mirror method, but it also has lower performance and availability characteristics in comparison to the mirror method.

In a virtual storage system, both the Mirror and the Parity method have the same usage costs in terms of disk space overhead as they do in a non-virtual storage system, but the granularity is such that each physical disk drive in the system can have one or more RAID arrays striped on it as well as both Mirror and Parity methods simultaneously. As such, a single physical disk drive may have data segments of some virtual disks on it as well as parity segments of other physical disks and both data and mirrored segments of other virtual disks.

These two redundant storage methods provide automated recovery from many common failures within the storage subsystem itself due to the use of data redundancy, error codes, and so-called “hot spares” (extra storage modules which may be activated to replace a failed, previously active storage module). These subsystems are typically referred to as redundant arrays of inexpensive (or independent) disks (or more commonly by the acronym RAID). The 1987 publication by David A. Patterson, et al., from University of California at Berkeley entitled A Case for Redundant Arrays of Inexpensive Disks (RAID), reviews the fundamental concepts of RAID technology.

There are five “levels” of standard geometries defined in the Patterson publication. The simplest array, a RAID 1 system, comprises one or more disks for storing data and a number of additional “mirror” disks for storing copies of the information written to the data disks. The remaining RAID levels, identified as RAID 2, 3, 4 and 5 systems, segment the data into portions for storage across several data disks. One of more additional disks are utilized to store error check or parity information. Additional RAID levels have since been developed. For example, RAID 6 is RAID 5 with double parity (or “P+Q Redundancy”). Thus, RAID 6 is an extension of RAID 5 that uses a second independent distributed parity scheme. Data is striped on a block level across a set of drives, and then a second set of parity is calculated and written across all of the drives. This configuration provides extremely high fault tolerance and can sustain several simultaneous drive failures, but it requires an “n+2” number of drives and a very complicated controller design. RAID 10 is a combination of RAID 1 and RAID 0. RAID 10 combines RAID 0 and RAID 1 by striping data across multiple drives without parity, and it mirrors the entire array to a second set of drives. This process delivers fast data access (like RAID 0) and single drive fault tolerance (like RAID 1), but cuts the usable drive space in half. RAID 10 requires a minimum of four equally sized drives (in a non-virtual disk environment) and 3 drives of any size in a virtual disk storage system), is the most expensive RAID solution and offers limited scalability in a non-virtual disk environment.

A computing system typically does not require knowledge of the number of storage devices that are being utilized to store the data because another device, the storage subsystem controller, is utilized to control the transfer of data to and from the computing system to the storage devices. The storage subsystem controller and the storage devices are typically called a storage subsystem and the computing system is usually called the host because the computing system initiates requests for data from the storage devices. The storage controller directs data traffic from the host system to one or more non-volatile storage devices. The storage controller may or may not have an intermediate cache to stage data between the non-volatile storage device and the host system.

Apart from data redundancy, some disk array data storage systems enhance data availability by reserving an additional physical storage disk that can be substituted for a failed storage disk. This extra storage disk is referred to as a “spare.” The spare disk is used to reconstruct user data and restore redundancy in the disk array after the disk failure, a process known as “rebuilding.” In some cases, the extra storage disk is actually attached to and fully operable within the disk array, but remains idle until a storage disk fails. These live storage disks are referred to as “hot spares”. In a large storage system with one or more types and sizes of physical drives, multiple “hot spares” may be required.

As described above, parity check data may be stored, either striped across the disks or on a dedicated disk in the array, on disk drives within the storage system. This check data can then be used to rebuild “lost” data in the event of a failed disk drive. Further fault tolerance can be achieved through the “hot swap” replacement of a failed disk with a new disk without powering down the RAID array. This is referred to as “failing back.” In a RAID system, the storage system may remain operational even when a drive must be replaced. Disk drives that may be replaced without powering down the system are said to be “hot swappable.”

When a disk drive fails in a RAID storage system, a hot-spare disk drive may be used to take the place of the failing drive. This requires additional disk drives in the storage system that are otherwise not utilized until such a failure occurs. Although these spares are commonly tested by storage systems on a regular basis, there is always a change that they will fail when put under a rebuild load. Also, as noted above, multiple hot spare sizes and performance levels may be necessary to handle the variety of drive sizes and styles found in a large virtualized storage system. Finally, as the size of physical disk drives in a storage system increases, the time needed to rebuild drives upon failure of a single drive goes up linearly.

It can be seen then that there is a need for a method, apparatus and program storage device that improves the speed and robustness of handling storage device failures in a storage system.

### SUMMARY OF THE INVENTION

To overcome the limitations in the prior art described above, and to overcome other limitations that will become apparent upon reading and understanding the present specification, the present invention discloses a method, apparatus and program storage device that provide virtual hot spare space to handle storage device failures in a storage system.

The present invention solves the above-described problems by migrating data from a failed storage device to a virtual hot spare storage device until a replacement storage device is hot swapped for the failed storage device. Once the replacement storage device is installed, the recovered data on the hot spare is moved back to the replacement storage device.

A method in accordance with the present invention includes detecting a failure of a storage device, allocating space for rebuilding the failed storage device's data and rebuilding the failed storage device's data in the allocated space.

In another embodiment of the present invention, another method for providing virtual space for handling storage device failures in a storage system is provided. This method includes preallocating virtual hot spare space for rebuilding data, detecting a failure of a storage device and rebuilding the failed storage device's data in the preallocated virtual host spare space.

In another embodiment of the present invention, a storage system for providing virtual space for handling storage device failures is provided. The storage system includes a processor and a plurality of storage devices, wherein the processor is configured for detecting a failure of a storage device, allocating space for rebuilding the failed storage device's data and rebuilding the failed storage device's data in the allocated space.

In another embodiment of the present invention, another storage system for providing virtual space for handling storage device failures is provided. This storage system includes a processor and a plurality of storage devices, wherein the processor is configured for preallocating virtual hot spare space for rebuilding data, detecting a failure of a storage device and rebuilding the failed storage device's data in the preallocated virtual host spare space.

In another embodiment of the present invention, a program storage device is provided. The program storage device tangibly embodies one or more programs of instructions executable by the computer to perform operations for providing virtual space for handling storage device failures in a storage system, wherein the operations include detecting a failure of a storage device, allocating space for rebuilding the failed storage device's data and rebuilding the failed storage device's data in the allocated space.

In another embodiment of the present invention, another program storage device is provided. This program storage device tangibly embodies one or more programs of instructions executable by the computer to perform operations for providing virtual space for handling storage device failures in a storage system, wherein the operations include preallocating virtual hot spare space for rebuilding data, detecting a failure of a storage device and rebuilding the failed storage device's data in the preallocated virtual host spare space.

In another embodiment of the present invention, another storage system for providing virtual space for handling storage device failures is provided. This storage system includes means for storing data thereon, means for detecting a failure of a means for storing data thereon, means for allocating space for rebuilding data of the failed means for storing data thereon and means for rebuilding the data of the failed means for storing data thereon in the allocated space.

In another embodiment of the present invention, another storage system for providing virtual space for handling storage device failures is provided. This storage system includes means for preallocating virtual hot spare space for rebuilding data, means for storing data thereon, means for detecting a failure of a means for storing data thereon and means for rebuilding the failed storage device's data in the preallocated virtual host spare space.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 shows a data storage system according to an embodiment of the present invention;

FIG. 2 illustrates the operation of a RAID storage system of FIG. 1;

FIG. 3 illustrates a storage system according to an embodiment of the present invention;

FIG. 4 illustrates a storage system according to an embodiment of the present invention; and

FIG. 5 illustrates a flow chart of a method for providing virtual space to handle storage device failures in a storage system according to an embodiment of the invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device that provide virtual hot spare space to handle storage device failures in a storage system. Data from a failed storage device is migrated to a hot spare storage device until a replacement storage device is hot swapped for the failed storage device. Once the replacement storage device is installed, the recovered data on the hot spare is moved back to the replacement storage device. Thus, the rebuild time after a drive failure, the recovery process after a replacement drive is provided and the handling of disparate sized physical device environments are improved. For example, the recovery process is improved after a replacement drive is provided by automating the recovery process as well as ensuring additional redundancy, such as bus and drive bay redundancy (via virtualization).

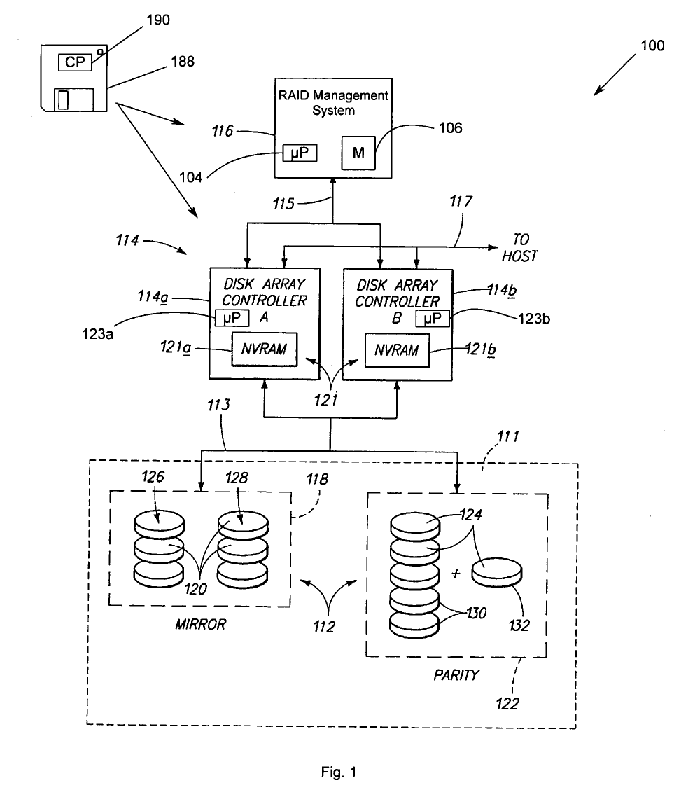

FIG. 1 shows a data storage system 100. The term “disk array” means a collection of disks, system which includes a hierarchic disk array 111 having a plurality of storage disks 112, a disk array controller 114 coupled to the disk array 111 to coordinate data transfer to and from the storage disks 112, and a RAID management system 116. Note that the RAID management system 116 may be a host computer system.

For purposes of this disclosure, a “disk” is any non-volatile, randomly accessible, rewritable mass storage device, which has the ability of detecting its own storage failures. It includes both rotating magnetic and optical disks and solid-state disks, or non-volatile electronic storage elements (such as PROMs, EPROMs, and EEPROMs). The term “disk array” is a collection of disks, the hardware required to connect them to one or more host computers, and management software used to control the operation of the physical disks and present them as one or more virtual disks to the host operating environment. A “virtual disk” is an abstract entity realized in the disk array by the management software.

Disk array controller 114 is coupled to disk array 111 via one or more interface buses 113, such as a small computer system interface (SCSI). RAID management system 116 is operatively coupled to disk array controller 114 via an interface protocol 115. Data memory system 100 is also coupled to a host computer (not shown) via an I/O interface bus 117. RAID management system 116 can be embodied as a separate component, or configured within disk array controller 114 or within the host computer.

The disk array controller 114 may include dual controllers consisting of disk array controller A 114a and disk array controller B 114b. Dual controllers 114a and 114b enhance reliability by providing continuous backup and redundancy in the event that one controller becomes inoperable. This invention can be practiced, however, with a single controller or other architectures.

The hierarchic disk array 111 can be characterized as different storage spaces, including its physical storage space and one or more virtual storage spaces. These various views of storage are related through mapping techniques. For example, the physical storage space of the disk array can be mapped into a virtual storage space, which delineates storage areas according to the various data reliability levels.

Data storage system 100 may include a memory map store 121 that provides for persistent storage of the virtual mapping information used to map different storage spaces into one another. The memory map store is external to the disk array, and preferably resident in the disk array controller 114. The memory mapping information can be continually or periodically updated by the controller or RAID management system as the various mapping configurations among the different views change.

The memory map store 121 may be embodied as two non-volatile RAMs (Random Access Memory) 121a and 121b that are located in respective controllers 114a and 114b. An example non-volatile RAM (NVRAM) is a battery-backed RAM. A battery-backed RAM uses energy from an independent battery source to maintain the data in the memory for a period of time in the event of power loss to the data storage system 100. One preferred construction is a self-refreshing, battery-backed DRAM (Dynamic RAM).

As shown in FIG. 1, disk array 111 has multiple storage disk drive devices 112. Example sizes of these storage disks are one to three Gigabytes. The storage disks can be independently connected or disconnected to mechanical bays that provide interfacing with SCSI bus 113. The data storage system 100 is designed to permit “hot swap” of additional storage devices into available bays in the array 111 while the array 111 is in operation.

As a background for understanding RAID configurations, the storage device 112 in array 111 can be conceptualized, for purposes of explanation, as being arranged in a mirror group 118 of multiple disks 120 and a parity group 122 of multiple disks 124. Mirror group 118 represents a first memory location or RAID area of the disk array that stores data according to a first or mirror redundancy level. This mirror redundancy level is also considered a RAID Level 1. RAID Level 1, or disk mirroring, offers the highest data reliability by providing one-to-one protection in that every bit of data is duplicated and stored within the data storage system. The mirror redundancy is diagrammatically represented by the three pairs of disks 120 in FIG. 1. Original data can be stored on a first set of disks 126 while duplicative, redundant data is stored on the paired second set of disks 128. The parity group 122 of disks 124 represent a second memory location or RAID area in which data is stored according to a second redundancy level, such as RAID Level 5. In this explanatory illustration of six disks, original data is stored on the five disks 130 and redundant “parity” data is stored on the sixth disk 132.

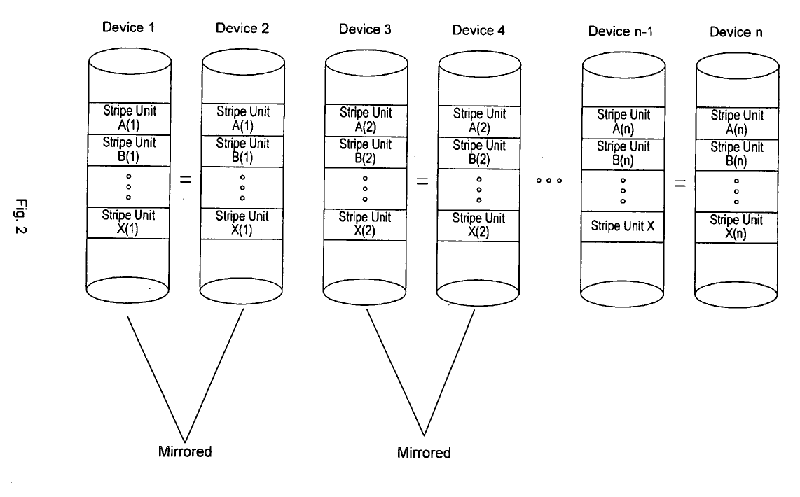

FIG. 2 illustrates the operation of a RAID storage system 100 of FIG. 1. RAID 10 is a combination of RAID 1 and RAID 0. RAID 10 combines RAID 0 and RAID 1 by striping data across multiple drives without parity, and it mirrors the entire array to a second set of drives. This process delivers fast data access (like RAID 0) and single drive fault tolerance (like RAID 1), but cuts the usable drive space in half. RAID 10 requires a minimum of four equally sized drives, is the most expensive RAID solution and offers limited scalability. FIG. 2 illustrates how data is stored in a typical RAID 10 system.

In FIG. 2, data is stored in stripes across the devices of the array. FIG. 2 shows data stripes A, B, . . . X stored across n storage devices. Each stripe is broken into stripe units, where a stripe unit is the portion of a stripe stored on each device. FIG. 2 also illustrates how data is mirrored on the array. For example, stripe unit A(1) is stored on devices 1 and 2, stripe unit A(2) is stored on devices 3 and 4, and so on. Thus, devices 1 and 2 form a mirrored pair, as do devices 3 and 4, etc. As can be seen from FIG. 2, this type of system will always require an even number of storage devices (2× the number of drives with no mirroring). This may a disadvantage for some users who have a system containing an odd number of disks. The user may be required to either not use one of his disks or buy an additional disk.

A storage array is said to enter a degraded mode when a disk in the array fails. This is because both the performance and reliability of the system (e.g. RAID) may become degraded. Performance may be degraded because the remaining copy (mirror copy) may become a bottleneck. To reconstruct a failed disk onto a replacement disk may require a copy operation of the complete contents of the mirror disk for the failed disk. The process of reconstructing a failed disk imposes an additional burden on the storage system. Also, reliability is degraded since if the second disk fails before the failed disk is replaced and reconstructed the array may unrecoverably lose data. Thus it is desirable to shorten the amount of time it takes to reconstruct a failed disk in order to shorten the time that the system operates in a degraded mode.

In the example of FIG. 2, if device 1 fails and is replaced with a new device, the data that was stored on device 1 is reconstructed by copying the contents of device 2 (the mirror of device 1) to the new device. During the time the new device is being reconstructed, if device 2 fails, data may be completely lost. Also, the load of the reconstruction operation is unbalanced. In other words, the load of the reconstruction operation involves read and write operations between only device 2 and the new device.

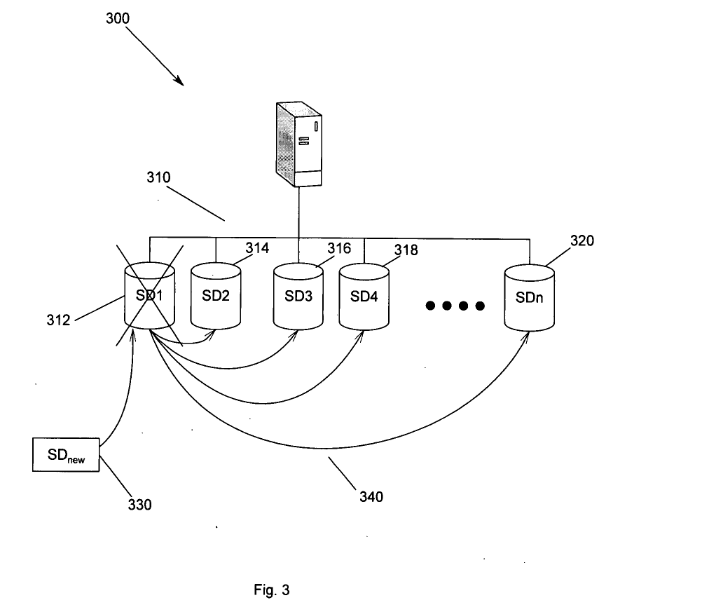

FIG. 3 illustrates a storage system according 300 to an embodiment of the present invention. FIG. 3 shows a storage system 300 having a plurality of storage devices 310. During operation of the storage system 300, a storage device 312 may fail. Spare space on the remaining storage devices 314-320 may be used to rebuild the data of the failed storage device 312. An amount of storage space must be available on the remaining storage devices 314-320 to replace the largest capacity storage device that may fail. When storage device 312 fails, space is allocated on some or all of the remaining available storage devices 314-320 to rebuild the data lost due to the failed storage device 312. Each logical block address d (LBA) range on the failing storage device 312 has to be copied 340 to the new range on at least one of the remaining storage device 314-320. Then the data allocated to the determined regions on the remaining storage devices 314-320 that was recovered from the failed storage device 312 may be migrated back to the replacement storage device 330 after the failed storage device 312 has been replaced.

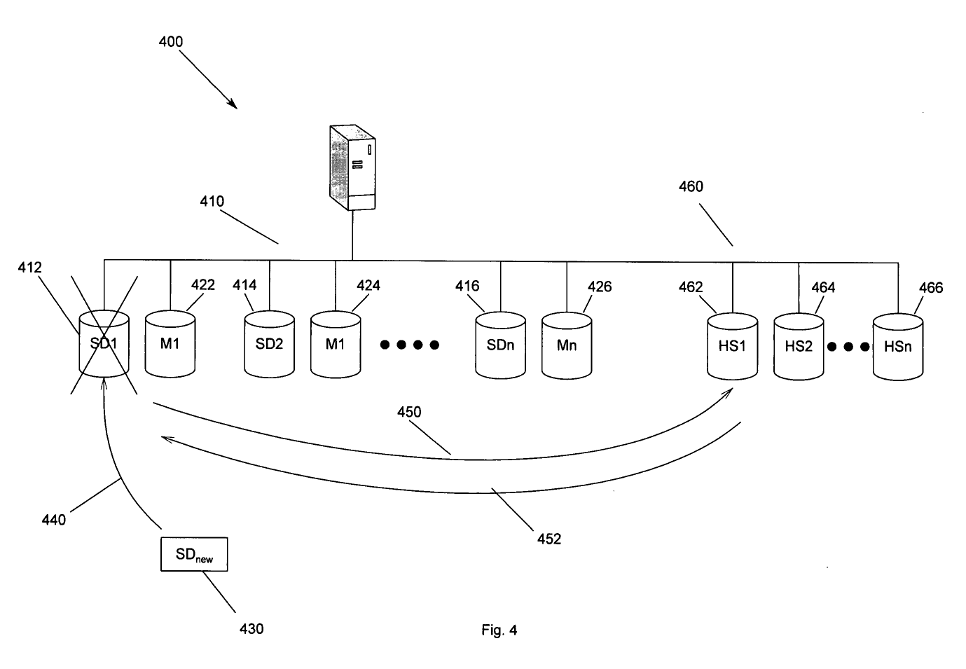

FIG. 4 illustrates a storage system according 400 to an embodiment of the present invention. In FIG. 4, the storage system 400 may be configured as a RAID 10 to combine RAID 0 and RAID 1 by striping data across multiple storage devices without parity, e.g., 412, 414, 416, and the entire array is mirrored to a second set of storage devices 422, 424, 426. The storage system 400 may also be configured with hot spares 460.

During operation of the storage system 400, a storage device 412 may fail. The hot spares 460 may be configured in any manner to provide redundancy for the storage devices 410 in the storage system 400. When a storage device fails 412, the storage device 412 may be rebuilt in significantly less time if the rebuilt physical disk is rebuilt 450 to an allocated region on the redundant hot spares 460, e.g., hot spares 462, 464, 466.

Rebuilding the failed storage device 412 on a redundant hot spare 462 also allows a restore from a rebuilt region to a replacement storage device 430 to be handled in a more logical fashion than is currently implemented in RAID storage systems, i.e., it allows the verification of maintenance of bus redundancy after a failed storage device 412 has been replaced 440 by a replacement storage device 430. For example, the failed storage device 412 may be hot swapped with a replacement storage device 430. Then the data on the hot spare 462 recovered from the failed storage device 412 may be migrated 452 back to the replacement storage device 430 after the failed storage device 412 has been replaced.

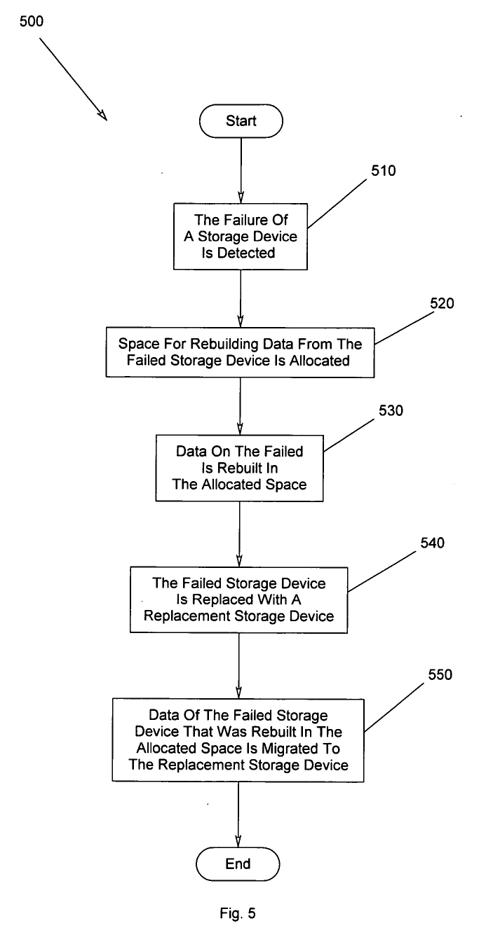

FIG. 5 illustrates a flow chart 500 of the method for providing virtual space to handle storage device failures in a storage system according to an embodiment of the invention. The failure of a storage device is detected 510. Space for rebuilding data from the failed storage device is allocated 520. Data on the failed is rebuilt in the allocated space 530. The space may be in a hot spare or in available space in the remaining storage devices. The failed storage device is replaced with a replacement storage device 540. Data of the failed storage device that was rebuilt in the allocated space is migrated to the replacement storage device 550.

The process illustrated with reference to FIGS. 1-5 may be tangibly embodied in a computer-readable medium or carrier, e.g. one or more of the fixed and/or removable data storage devices 188 illustrated in FIG. 1, or other data storage or data communications devices. The computer program 190 may be loaded into any of memory 106, 121a, 121b to configure any of processors 104, 123a, 123b for execution of the computer program 190. The computer program 190 include instructions which, when read and executed by processors 104, 123a, 123b of FIG. 1, causes processors 104, 123a, 123b to perform the steps necessary to execute the steps or elements of an embodiment of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A method for providing virtual space for handling storage device failures in a storage system, comprising:
detecting a failure of a storage device;
allocating space for rebuilding the failed storage device's data; and
rebuilding the failed storage device's data in the allocated space.

2. The method of claim 1 further comprising:
replacing the failed storage devices with a replacement storage device; and
migrating the data rebuilt in the allocated space to the replacement storage device.

3. The method of claim 2, wherein the replacing the failed storage device comprises hot swapping a new storage device for the failed storage device.

4. The method of claim 1, wherein the allocating space further comprises allocating unused space in storage devices of the storage system remaining after the failure of the storage device.

5. The method of claim 1, wherein the allocating space further comprises allocating space in hot spares for rebuilding data on the failed storage device.

6. A method for providing virtual space for handling storage device failures in a storage system, comprising:
preallocating virtual hot spare space for rebuilding data;
detecting a failure of a storage device; and
rebuilding the failed storage device's data in the preallocated virtual host spare space.

7. The method of claim 6 further comprising placing into a general use storage pool any of the virtual hot spare space not used during rebuilding the failed storage device's data.

8. The method of claim 6 further comprising setting aside for subsequent storage device failures any of the virtual hot spare space not used during rebuilding the failed storage device's data.

9. The method of claim 8, wherein the preallocated virtual hot spare space is mirrored, parity or striped over at least one physical storage device.

10. A storage system for providing virtual space for handling storage device failures, comprising:
a processor; and
a plurality of storage devices;
wherein the processor is configured for detecting a failure of a storage device, allocating space for rebuilding the failed storage device's data and rebuilding the failed storage device's data in the allocated space.

11. The storage system of claim 10, wherein the processor is further configured for migrating the data rebuilt in the allocated space to a replacement storage device replacing the failed storage device.

12. The storage system of claim 11, wherein the processor is further configured for migrating the data rebuilt in the allocated space to a hot swapped storage device replacing the failed storage device.

13. The storage system of claim 10, wherein the processor is further configured for allocating unused space in the plurality of storage devices remaining after the failure of the storage device.

14. The storage system of claim 10, wherein the processor is further configured for allocating space in hot spares for rebuilding data on the failed storage device.

15. The storage system of claim 10, wherein the processor is disposed in a controller.

16. The storage system of claim 10, wherein the processor is disposed in a management system.

17. A storage system for providing virtual space for handling storage device failures, comprising:
a processor; and
a plurality of storage devices;
wherein the processor is configured for preallocating virtual hot spare space for rebuilding data, detecting a failure of a storage device and rebuilding the failed storage device's data in the preallocated virtual host spare space.

18. The storage system of claim 17, wherein the processor places into a general use storage pool any of the virtual hot spare space not used during rebuilding the failed storage device's data.

19. The storage system of claim 17, wherein the processor sets aside for subsequent storage device failures any of the virtual hot spare space not used during rebuilding the failed storage device's data.

20. The storage system of claim 19, wherein the preallocated virtual hot spare space is mirrored, parity or striped over at least one physical storage device.

21. A program storage device readable by a computer, the program storage device tangibly embodying one or more programs of instructions executable by the computer to perform operations for providing virtual space for handling storage device failures in a storage system, the operations comprising:
detecting a failure of a storage device;
allocating space for rebuilding the failed storage device's data; and
rebuilding the failed storage device's data in the allocated space.

22. The program storage device of claim 21 further comprising:
replacing the failed storage devices with a replacement storage device; and
migrating the data rebuilt in the allocated space to the replacement storage device.

23. The program storage device of claim 22, wherein the replacing the failed storage device comprises hot swapping a new storage device for the failed storage device.

24. The program storage device of claim 21, wherein the allocating space further comprises allocating unused space in storage devices of the storage system remaining after the failure of the storage device.

25. The program storage device of claim 21, wherein the allocating space further comprises allocating space in hot spares for rebuilding data on the failed storage device.

26. A program storage device readable by a computer, the program storage device tangibly embodying one or more programs of instructions executable by the computer to perform operations for providing virtual space for handling storage device failures in a storage system, the operations comprising:
preallocating virtual hot spare space for rebuilding data;
detecting a failure of a storage device; and
rebuilding the failed storage device's data in the preallocated virtual host spare space.

27. The program storage device of claim 26 further comprising placing into a general use storage pool any of the virtual hot spare space not used during rebuilding the failed storage device's data.

28. The program storage device of claim 26 further comprising setting aside for subsequent storage device failures any of the virtual hot spare space not used during rebuilding the failed storage device's data.

29. The program storage device of claim 28, wherein the preallocated virtual hot spare space is mirrored, parity or striped over at least one physical storage device.

30. A storage system for providing virtual hot spare space for handling storage device failures, comprising:
means for storing data thereon;
means for detecting a failure of a means for storing data thereon;
means for allocating space for rebuilding data of the failed means for storing data thereon; and
means for rebuilding the data of the failed means for storing data thereon in the allocated space.

31. A storage system for providing virtual space for handling storage device failures, comprising:
means for preallocating virtual hot spare space for rebuilding data,
means for storing data thereon;
means for detecting a failure of a means for storing data thereon; and
means for rebuilding the failed storage device's data in the preallocated virtual host spare space.
